(19) United States
(12) Patent Application Publication
(10) Pub. No.: US 2003/0168148 A1
(43) Pub. Date: Sep. 11, 2003

(54) Apparatus and method for printing and cutting customized wall decorations

(75) Inventors: David Gerber, West Hartford, CT (US); Thomas Gordon, South Glastonbury, CT (US)

Correspondence Address: Marina F. Cunningham, McCormick, Paulding & Huber LLP, CityPlace II, 185 Asylum Street, Hartford, CT, 06103, US

(73) Assignee: Gerber Scientific Products, Inc., South Windsor, CT

(21) Appl. No.: 10/353,587

(22) Filed: Jan. 29, 2003

Related U.S. Application Data
(60) Provisional application No. 60/354,011, filed on Jan. 30, 2002.

(51) Int. Cl. B32B 31/00

(52) U.S. Cl. 156/71; 156/277

(57) ABSTRACT

A system for generating a printed product includes a printer, a cutter, and a computer. The printer and cutter are controlled by the computer to generate printed and/or contoured cut products, such as wall boarders, murals, stencils, and appliques as well as wallpaper of extremely high quality. The system, according to the present invention, allows the printed product to be customized to individual design, color and size requirements. The system of the present invention results in time and cost savings and allows complete flexibility in choices for wall boarders, murals, stencils, appliques and wallpaper.

### CROSS REFERENCE TO RELATED APPLICATIONS

This application claims priority from and incorporates herein by reference U.S. Provisional patent application Serial No. 60/354,011 filed on Jan. 30, 2002.

### BACKGROUND OF THE INVENTION

1. Technical Field

This invention relates to an apparatus and method for customized printing and cutting of wall decorations.

2. Background Art

The advent of computers and worldwide web has revolutionized and automated many aspects of our lives. For example, orders for stocks can be placed over the Internet and clothing and wares can be purchased or even designed without leaving home. However, some aspects of everyday life have remained painfully time-consuming and logistically frustrating. For example, selection of wallpaper, borders and/or murals to match a certain pattern during a redecoration project is a long and highly labor-intensive process. Typically, matching of wallpaper, borders and/or murals to existing curtain pattern, couch pattern or carpet pattern requires settling for a pattern that may be close to the desired pattern, but rarely identical. Therefore, most people are relegated to settling for a near match rather than obtaining exactly what they would like. Additionally, searching even for a near match requires significant time and energy investment necessitating traveling from store to store with a sample of curtain or couch material to be matched or searching on the Internet.

Additionally, many people favor stenciled walls or borders or appliques on their walls. Stencils and appliques are extremely time and labor intensive. Typically, stencil work requires one to paint around the stencil in the most inconvenient positions.

Manufacturers of wallpaper products typically produce several designs of the product in high quantities to justify tooling costs. However, the high quantity of the same product requires that the manufacturer carry large inventories of the product, which is not a desirable outcome. Additionally, large quantities of the same product may leave the manufacturer with large quantities of unsold product if the product was not as successful as it was initially or if the styles have changed.

Therefore, it would be desirable to provide an apparatus and method for producing customized borders, murals, stencils and appliques, as well as wallpaper.

### SUMMARY OF THE INVENTION

It is an object of the present invention to generate high quality customized printed product potentially having an intricate contour.

According to the present invention, a system including a printer and a cutter is controlled by a computer to generate printed and/or contoured cut products, such as wall borders, murals, stencils, and appliques of extremely high quality.

The system of the present invention allows high quality of printing and/or cutting of wall borders, murals, stencils, and appliques that are customized to individual's design, color and size requirements. Not only does the present invention result in time and cost savings, it also allows complete flexibility in choices.

The foregoing and other advantages of the present invention become more apparent in light of the following detailed description of the exemplary embodiments thereof, as illustrated in the accompanying drawings.

### BRIEF DESCRIPTION OF THE DRAWINGS

FIG. 1 is a schematic diagram of a system for generating a printed product including a printer, a cutter, and a computer, according to the present invention; and

FIG. 2 is a schematic view of a sheet material generated through use of the system of FIG. 1.

### DETAILED DESCRIPTION OF THE INVENTION

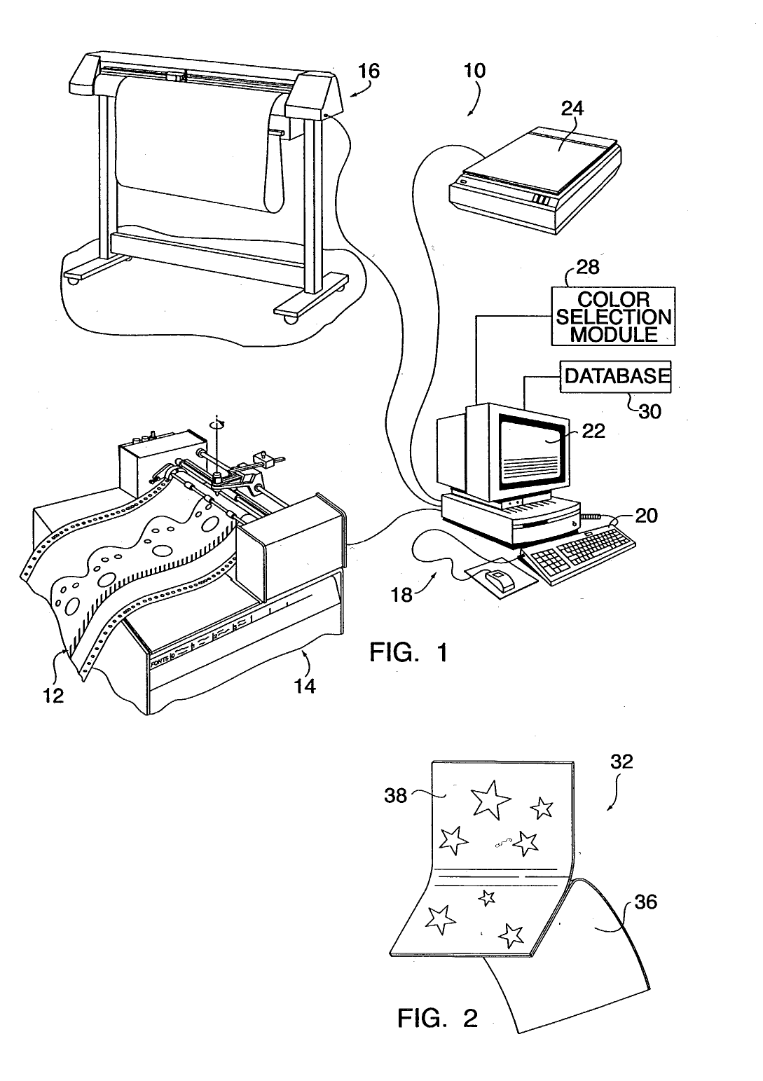

Referring to FIG. 1, a system 10 for generating a printed product 12 includes a printer 14, a cutter 16, and a computer 18. Various types of printers having a high quality of print can be used. Also, various types of cutters can be used with this system. Some examples of printers that can be used are of a type manufactured by the assignee of the present application, Gerber Scientific Products, Inc. of South Windsor, Conn., being sold under the name of GERBER EDGE™ and/or MAXX™, as described in U.S. Pat. Nos. 5,537,135; 6,322,265 and 6,243,120, incorporated herein by reference. One type of cutter that can be used is of a type also manufactured by the assignee of the present application, Gerber Scientific, Inc., as described in U.S. Pat. Nos. 4,467,525; 5,868,507; 6,138,885, incorporated herein by reference.

The computer 18 is in communication with the printer 14 and the cutter 16 and includes a processor (not shown) for generating and analyzing instructions and data, an operating panel 20 for accepting input data and information, and a monitor 22 for viewing printed designs. The computer may also include a scanner 24 for allowing scanned prints to be viewed and modified. The scanner can be also used to scan in existing designs and/or patterns to be matched and/or modified.

The computer also includes a color module 28 and at least one database 30 with various images and designs as well as capability for the customer input his/her own design. The color module 28 may include various sub-modules for selecting and matching colors of the product to the scanned colors and/or desired colors and for printing the selected colors on the printer. The various sub-modules may include, but are not limited to, Spectrophotometer, Pantone® products, such as Pantone® System Guide and/or Pantone Color Simulator, products of Pantone®, Inc. Carlstadt, N.J., as well as various products by Gerber Scientific, Inc., of South Windsor, Conn., such as Graphix Advantage®, Omega™ and/or Color Way™.

In operation, an operator chooses or designs a desired image. For example, the operator may elect to scan an existing pattern through the scanner 24 into the computer 18. The operator may then either use the scanned image or alter the scanned image by enlarging, duplicating or modifying the image, including change of coloring. Alternatively, the operator may elect to design a unique image or choose one or more images from a selection of images available/residing in the system. Ideally, the system includes an image library database of various images and designs that can be selected, combined and/or modified. Additionally, the customer may want to include text into the design. The operator can choose from various colors to identically match the desired coloring scheme.

Once an image is selected and modified to satisfaction, the image is printed by the printer 14 on sheet material 32 in accordance with the printing instructions generated by the processor. The material 32 includes a top printable layer or substrate 34, and, possibly, a removable backing sheet 36 with an adhesive layer 38 sandwiched therebetween, as shown in FIG. 2. Alternatively, a light tack adhesive can be used, either pre-applied to the substrate or applied to the back of the material at the time of printing. The printed image is then transferred to the cutter 16 and cut around the perimeter and/or contour of the image in accordance with the cutting instructions communicated by the processor.

The printed product 12 can have intricate printed design as well as intricate contour since both, the printer 14 and cutter 16, designed by Gerber Scientific, Inc., are geared to handle high quality printing and accurate cutting, respectively. Although the present invention is well suited for printing and cutting intricate designs and contours, the apparatus of the present invention can be also used to print and cut wallpaper and the like of various standard and non-standard width. Thus, if a customer needs wallpaper products of non-standard width, the apparatus of the present invention accommodates customer's particular needs. In addition, the printed product 12 can be generated on any type of material including, but not being limited to, self-adhesive material, as shown in FIG. 2, non-self-adhesive material, or removable material.

The printed product 12 generated by system 10 of the present invention can be borders for use in combination with wallpaper to match the design thereof or borders to be placed onto walls and matched to the paint. The borders can have intricate printed design and/or intricate contour. In addition, the printed product 12 can be a mural of any size or shape. Furthermore, the apparatus of the present invention is geared to generate stencils. Typically, stencils have very elaborate contour and design. Both, the printer 14 and the cutter 16 are capable of printing and cutting such elaborate and intricate designs. The stencils can, therefore, be cut to such elaborate contour and customized for certain shapes. Moreover, various appliques can be printed and cut using the apparatus of the present invention.

For wall borders and stencils, the customer may choose to have either a repeated image or non-repeated image. For the repeated image, the customer may choose precise location in the room where to begin the repeat in the design. For non-repeated image, the customer may either shrink or expand the image to exactly fit the dimensions of the room or location where the product will be placed. Moreover, the customer can specifically identify which portions of the design are to be stretched or shrunk to fit the predetermined dimensions of the final product. This feature is particularly useful for designing wall product for a room with corners. More specifically, the product can be printed to make accommodations for corners—such as either stop the design few inches prior to a corner or insert a specific design for the corners.

Furthermore, system 10 can generate banners, either temporary or durable. The temporary banners can be printed on inexpensive paper stock, while durable banners can be printed on lasting vinyl stock. Some banners can be printed on pre-printed holiday motif stock with customized features added thereto. Various customized features, such as text or design, can be added to the banners. Such capability will allow the customer to have banners with various messages that match the customer's existing color scheme and/or design.

According to one aspect of the present invention, the system 10 can be disposed within a store, as a kiosk, or accessed remotely via Internet, wherein the store option allows customers to have the desired product generated before leaving the store. Thus, the customer may wait for the product to be generated substantially immediately. With the Internet option, customer may have the customized product sent to her/him without leaving home. The kiosk concept and the Internet concept were disclosed in patent application Ser. No. 10/034,948, assigned to the same assignee herewith, and incorporated by reference herein.

One major advantage of the present invention is that it allows customizing various products to specific needs of a customer. Furthermore, the apparatus and method of the present invention reduce cost and labor required for generating products of similar quality.

While the present invention has been illustrated and described with respect to a particular embodiment thereof, it should be appreciated by those of ordinary skill in the art, that various modifications to this invention may be made without departing from the spirit and scope of the present invention.

We claim:

1. A method for generating a printed product for being applied onto a wall, said method comprising the steps of:
generating an image;
printing said image in a printer to generate a printed product; and
cutting around said image to define said printed product.

2. The method according to claim 1, further comprising an additional step of:
applying said printed product onto a wall.

3. The method according to claim 2 wherein said printed product is applied to a wall permanently.

4. The method according to claim 1, further comprising a step of:
matching color of said image to a predetermined color.

5. The method according to claim 1, further comprising a step of:
printing said image in a predetermined length.

6. The method according to claim 1, wherein said image is printed on self-adhesive material.

7. The method according to claim 1, wherein said image is fitted to be printed in a predetermined length.

8. The method according to claim 1, wherein said image is color matched within said computer.

9. The method according to claim 1, wherein said step of generating an image comprises a step of selecting an image from an existing database.

10. The method according to claim 1, wherein said step of generating an image comprises a step of designing a new image.

11. The method according to claim 1, wherein said step of generating an image comprises a step of scanning in an existing image.

12. The method according to claim 1, wherein said step of generating an image comprises steps of scanning in an existing image and subsequently customizing said existing image.

13. The method according to claim 1 wherein said image is cut to define a contour of said printed product.

14. The method according to claim 13 wherein said contour is intricate.

15. The method according to claim 1 wherein said image is cut to define various widths of said printed product.

16. An apparatus for generating a printed product for being applied onto a wall, said apparatus comprising:
a computer for generating an image;
a printer for printing said image; and
a cutter for cutting around said image for subsequent application of said image onto a wall.

17. The apparatus according to claim 16, further comprising:
a scanner for scanning an existing image for subsequent printing.

18. The apparatus according to claim 16, wherein said image is printed on self-adhesive material.

19. The apparatus according to claim 16 further comprising:
means for color matching said image to a predetermined color.

20. The apparatus according to claim 16 wherein said printed product is applied to a wall permanently.

21. The apparatus according to claim 16 wherein said image is cut to define a contour of said printed product.

22. The apparatus according to claim 21 wherein said contour is intricate.

23. The apparatus according to claim 21 wherein said image is cut to define various widths of said printed product.
